(19) United States
(12) Patent Application Publication
(10) Pub. No.: US 2020/0343616 A1
(43) Pub. Date: Oct. 29, 2020

(54) FREQUENCY SELECTIVE CAPACITIVELY TUNED GROUND BONDS FOR HIGH ISOLATION IN RF DEVICES

(71) Applicant: Raytheon Company, Waltham, MA (US)

(72) Inventors: Elicia K. Harper, Chelsea, MA (US); Christopher M. Laighton, Boxborough, MA (US); Michael T. Borkowski, Bedford, NH (US)

(73) Assignee: Raytheon Company, Waltham, MA (US)

(21) Appl. No.: 16/392,989

(22) Filed: Apr. 24, 2019

(51) Int. Cl. H01P 7/06; H01P 3/02; H01P 3/08; H01P 3/00

(52) U.S. Cl. CPC H01P 7/065; H01P 3/003; H01P 3/081; H01P 3/026

(57) ABSTRACT

A first RF module has a port, such port having a first signal conductor and a first ground plane conductor. A second RF module has a port spaced from the port of the first RF module and having a second signal conductor and a second ground plane conductor. A ground bridging conductor, bridging a space between the ports of the first and second RF modules, has a first end connected to the first ground plane conductor and a second end connected to the second ground plane conductor. A signal bridging conductor, bridging the space between ports of the first and second RF modules has a first end connected to the first signal conductor and second end connected to the second signal conductor. A capacitor is connected between the ground plane bridging conductor and one of the first ground plane conductor and the second ground plane conductor.

### TECHNICAL FIELD

This disclosure relates generally to assemblies having interconnected radio frequency (RF) modules and more particularly to such assemblies having improved RF isolation properties.

### BACKGROUND OF THE INVENTION

As is known in the art, it is frequently desirable to connect one RF module, such as a printed circuit board (PCB) having a plurality of input or output ports to a second RF module, such as Monolithic Microwave Integrated Circuit (MIMIC). A portion of one such an arrangement is shown in FIG. 1. Here a pair of input/outputs coplanar waveguide (CPW) ports PORT A and PORT B, of the PCB are connected a pair of input/output ports, here microstrip ports, PORT C and PORT D, of a MIMIC, respectively, as shown. It is noted that the ports A and B are spaced from the Ports C and D. It also noted that the microwave transmission lines of the PCB in this example, are stripline circuitry having an upper and lower dielectric board with ground plane conductors on their outer surfaces and with signal conductors on the upper surface of the lower dielectric board and a conductive layer on the upper surface of the lower dielectric board but separated sufficiently from the signal conductor to enable stripline transmission; however, a notch is formed in the upper dielectric board to provide for the CPW input/output ports A and B; for the PCB; it being noted that here the middle ground plane conductors are also sufficiently close to the signal strip conductors in the notch to provide the ground strip conductors for the signal strip conductors of the CPW ports A and B. It is noted that the upper, middle and lower ground plane conductors are interconnected by vertical electrically conductive vias passing through the dielectric boards. The arrangement in an exemplary one of the notches is shown in FIG. 2. Referring again also to FIG. 1, it is noted the CPW ports A and B are connected to ports C and D respectively of the MIMIC that uses microstrip transmission line circuitry by bridging conductors: a pair of ground plane bridging conductors that span the space between the ports A and B and the ports C and D; and a pair of signal bridging conductors that span the space between the ports A and B and the ports C and D, as showing in FIGS. 1 and 2; the ground plane bridging conductors being connected to the ground plane on the bottom of the MIMIC through the conducive via and the signal bridging conductors being connected to the signal strip conductor on the upper surface of the MMIC board, as shown. While such an arrangement functions adequately in many applications signal at port C (FIG. 1) may interfere with signals at port B and likewise the signals at port D may interfere with the signals at port A. Several approaches have been use to solve this interference problem, as shown in FIGS. 3A and 3B. However, this method improving isolation currently consist of adding ground wire or ribbon bonds to the ground signal ground pads going between an RF module board (the MIMIC) and PCB. This can be further enhanced by adding additional ground bonds to those pads in various configurations. This solution is limited due to the inductive impedance of the ground wires. It can cause problems in assembly, increases risk of ground and signal wires shorting and is space limited.

### SUMMARY OF THE INVENTION

In accordance with the present disclosure, an assembly is provided having interconnected radio frequency (RF) modules, comprising: a first RF module having a port having a first signal conductor and a first ground plane conductor; a second microwave a port, such port being spaced from the port of the first RF module and having a second signal conductor and a second ground plane conductor; a ground bridging conductor bridging the space between the port of the first RF module and the port of the second RF module and having a first end connected to the first ground plane conductor and a second end connected to the second ground plane conductor; a signal bridging conductor bridging the space between the port of the first RF module and the port of the second RF module and having a first end connected to the first signal conductor and second end connected to the second signal conductor; and a capacitor connected between the ground plane bridging conductor and one of the first ground plane conductor and the second ground plane conductor.

In one embodiment, an assembly is provided having interconnected radio frequency (RF) modules, comprising: a first RF module, comprising a first dielectric substrate; a first signal strip conductor disposed on a surface of the first dielectric substrate; and, a first ground plane conductor disposed on the surface of the first substrate and arranged to support RF energy between the first signal conductor and the first ground plane conductor. The assembly includes: a second RF module, comprising: a second dielectric substrate; a second signal strip conductor disposed on a surface of the second dielectric substrate; a second ground plane conductor, disposed on a surface of the second substrate under the surface having thereon the second signal strip conductor, connected to the second ground plane conductor through the second dielectric substrate. A ground bridging conductor has a first end connected to the first ground plane conductor and a second end connected to the second ground plane conductor. A signal bridging conductor has a first end connected to the first signal conductor and second end connected to the second signal conductor. A capacitor is disposed connected between the ground plane bridging conductor and one of the first ground plane conductor and the second ground plane conductor.

In one embodiment, the capacitor is on disposed one of the first RF module and the second RF module.

In one embodiment, the bridging ground plane conductor and the capacitor form a series resonant circuit tuned to a frequency of RF energy passing through the ground bringing conductor.

With such an arrangement, isolation is improved without needing additional ground bonds. This monolithic solution gives additional isolation to the circuit without having to add additional bond wires to the circuit and can be easily integrated into the MIMIC design. Rather than the ground portion of the ground signal ground bond pads going directly to ground, there is a series ground capacitor added is series between the bridging ground conductor and the ground plane of the MIMIC. The value of the capacitor is an application specific value. Single ground-signal-ground bonds are then added to the circuitry to achieve this solution.

The details of one or more embodiments of the disclosure are set forth in the accompanying drawings and the description below. Other features, objects, and advantages of the disclosure will be apparent from the description and drawings, and from the claims.

### BRIEF DESCRIPTION OF THE DRAWINGS

FIG. 1 is an isometric view of an assembly having interconnected radio frequency (RF) modules according to the PRIOR ART;

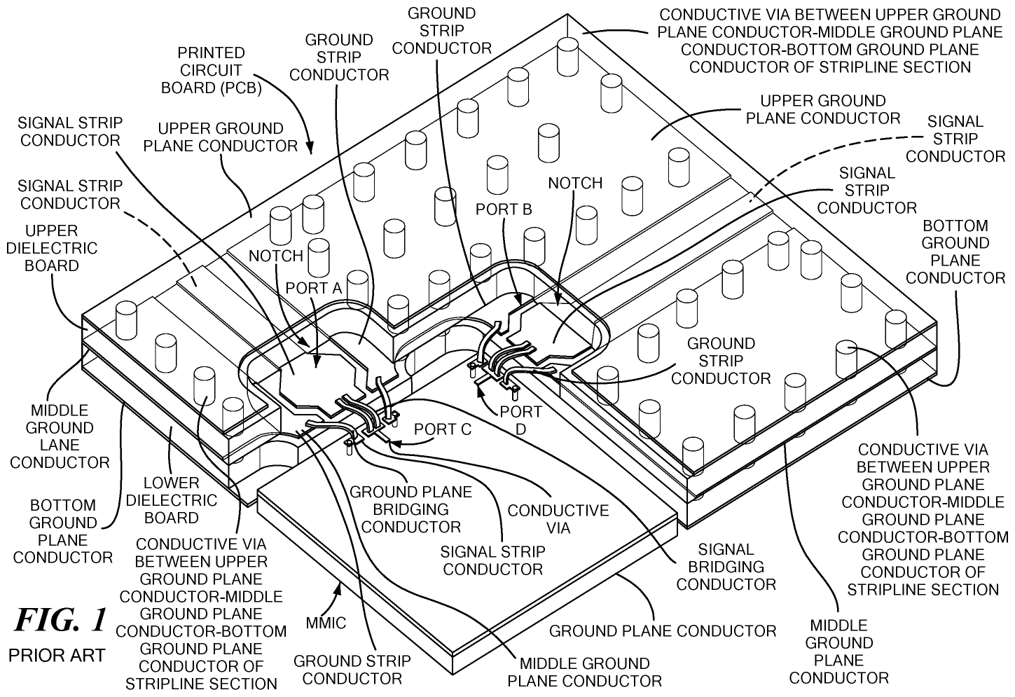

FIG. 2 is an enlarged plan view of the assembly of FIG. 1 according to the PRIOR ART;

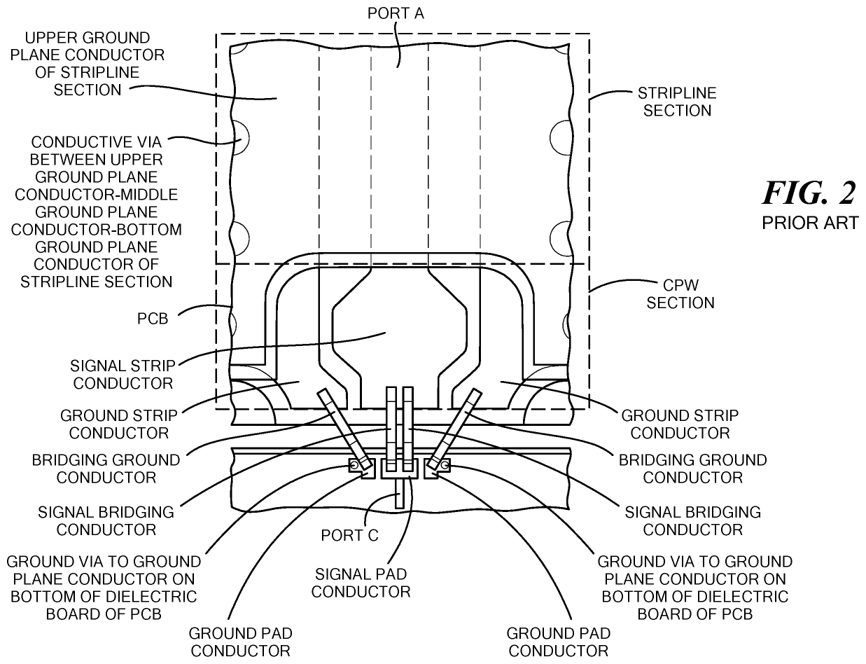

FIG. 3A is an enlarged plan view of an assembly having interconnected radio frequency (RF) modules according to the PRIOR ART;

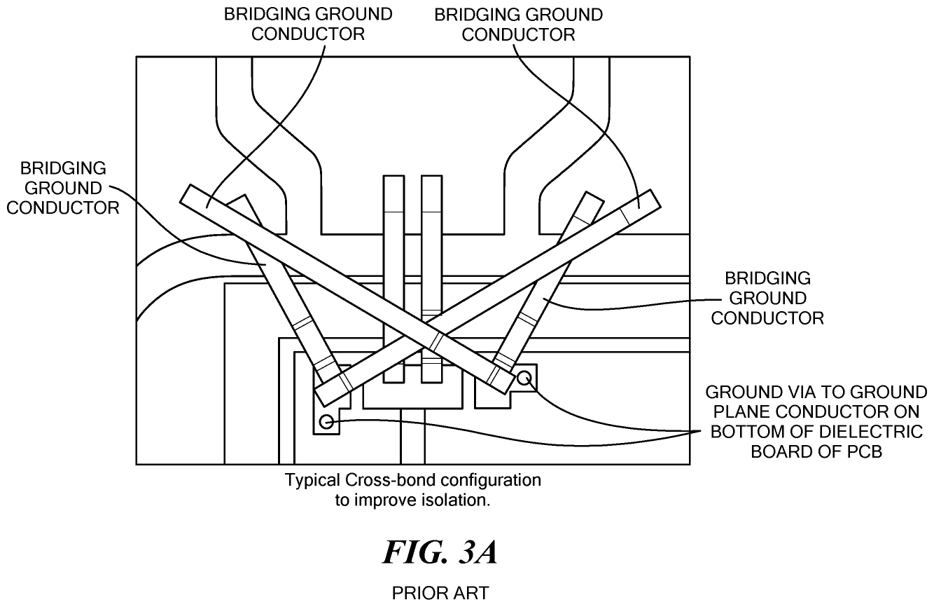

FIG. 3B is an enlarged plan view of an assembly having interconnected radio frequency (RF) modules according to the PRIOR ART

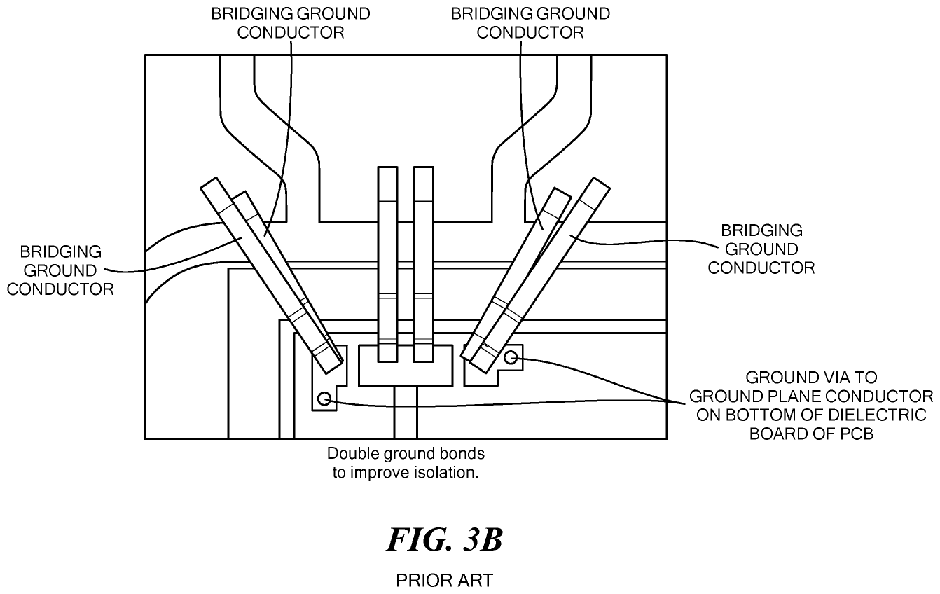

FIG. 4 is an isometric view of an assembly having interconnected radio frequency (RF) modules according to the disclosure;

FIG. 4A is an isometric view of an enlarged portion of assembly of FIG. 4 according to the disclosure;

FIG. 4B is cross-sectional view of an enlarged portion of assembly of FIG. 4 according to the disclosure, such cross-section being taken along line 4B-4B in FIG. 4A;

FIG. 4C is a schematic view of the cross-sectional view of FIG. 4B according to the disclosure; and

FIG. 5 is an isometric view of an enlarged portion of assembly having interconnected radio frequency (RF) modules according to another embodiment of the disclosure.

Like reference symbols in the various drawings indicate like elements.

### DETAILED DESCRIPTION

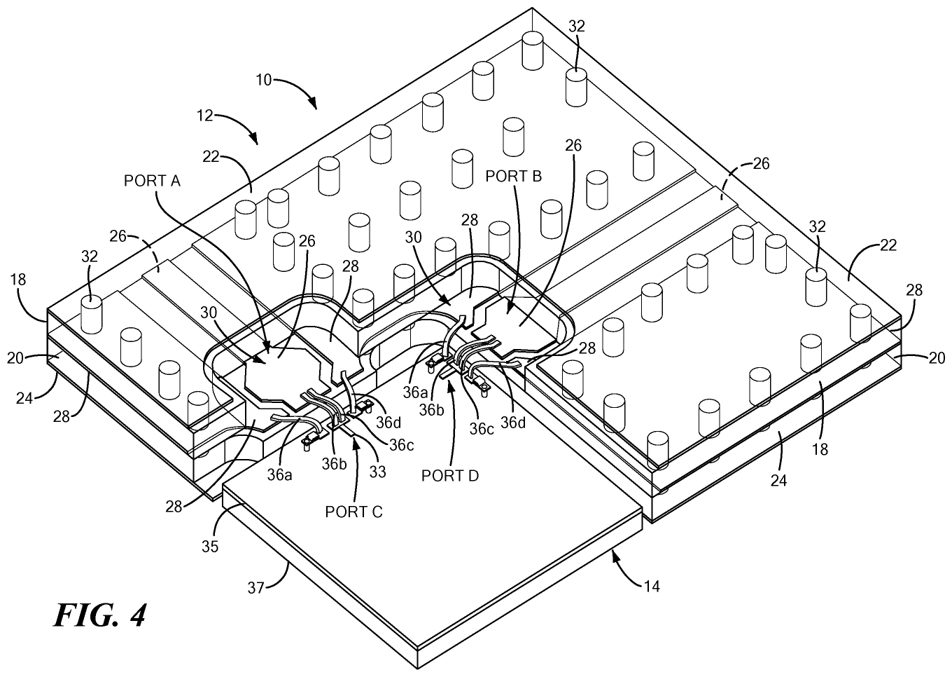

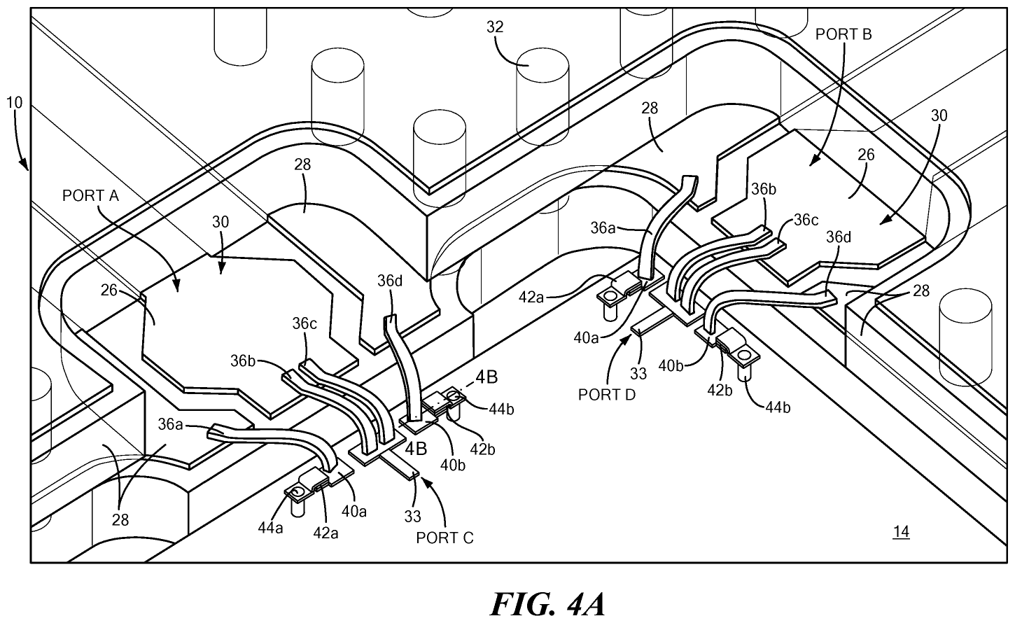

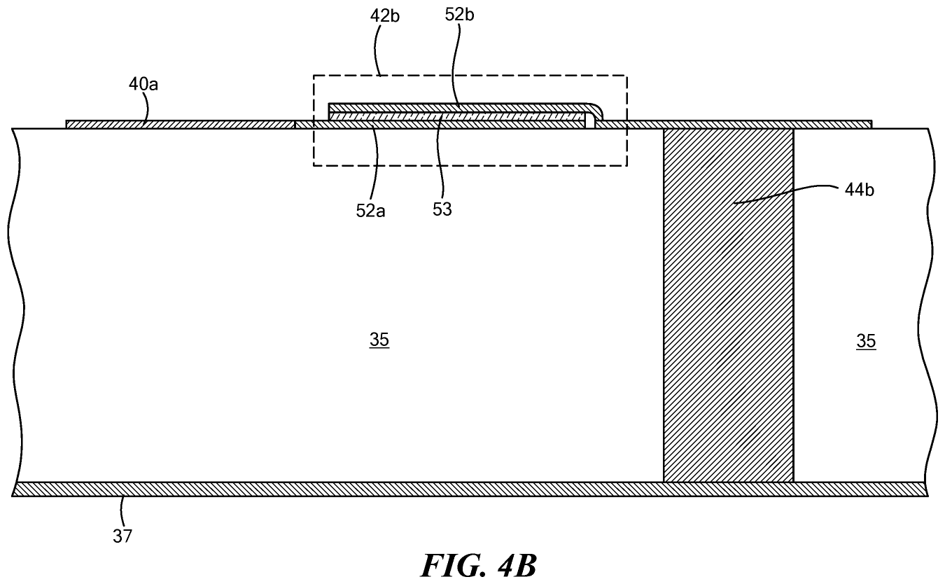

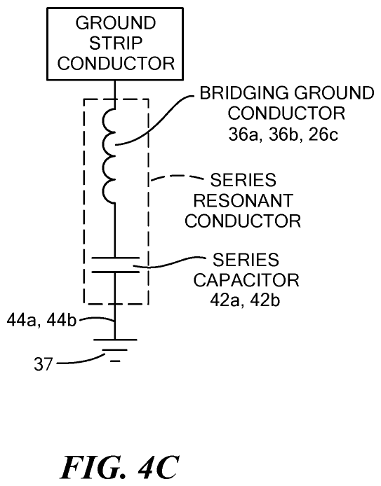

Referring now to FIGS. 4 and 4A, an assembly 10 is shown having interconnected radio frequency (RF) modules; here printed circuit board (PCB) module 12 and a MIMIC module 14. More particularly, FIGS. 4A and 4B show, the PCB module 12 having a plurality of, here two, input/output ports PORT A and PORT B connected to a pair of input/output ports PORT C and PORT D, respectively of the second RF module 14. Here, the pair of input/outputs of PCB module 12 are coplanar waveguide (CPW) ports PORT A and PORT B, and the pair of ports C and D of the MIMIC module 14 are microstrip ports, PORT C and PORT D, as shown. It also noted that the microwave transmission lines of the PCB 12 connected to ports A and B, in this example, are stripline circuitry having an upper and lower dielectric board 18, 20 with ground plane conductors 22, 24 on their outer surfaces and with signal conductors 26 on the upper surface of the lower dielectric board 20 and a conductive ground plane conductors 28 on the upper surface of the middle dielectric board 20 but separated sufficiently from the signal conductors 26 to enable a stripline transmission line to be formed; however, a notches 30 are formed in the upper dielectric board 18 to provide for the CPW input/output ports A and B for the PCB 12; it being noted that here the middle ground plane conductors 28 also sufficient close to the signal strip conductors 26 in the notch 30 to provide the ground strip conductors for the signal strip conductors 26 and thus CPW ports A and B. It is noted that the upper, middle and lower ground plane conductors 22, 24 are interconnected by vertical electrically conductive vias 32 passing through the dielectric boards 18, 20. The notches 30 and PORTS A, B, C and D and electrical interconnects connecting the ports in notches 30 are shown in more detail in FIG. 4A.

The MIMIC module 14 has strip conductors 33 on the upper surface of a dielectric substrate 35 (FIG. 4) and a ground plane conductor 37 (FIG. 4) on the bottom surface of the dielectric substrate 35 to provide for microstrip transmission lines which interconnect electrical devices, not shown, on the MIMIC 16 in any conventional manner,

Referring again also to FIG. 4, it is noted that the ports A and B are spaced from the ports C and D. It is also noted the CPW ports A and B of the PCB module 12 are connected to ports C and D of the MMIC module 14 two sets of bridging conductors 36a, 36b, 36c, and 36d, as shown more clearly in FIG. 4A; a pair of ground plane bridging conductors 36a and 36d that span the space between the ports A and B and the ports C and D and a pair of signal bridging conductors 36b and 36c and that span the space between the ports A and B and the ports C and D, as showing in FIGS. 4 and 4A. It should be noted that: on the PCB module 12 side of the assembly 10, ends of the ground plane bridging conductors 36a and 36d are connected to the ground plane conductors 28 of the CPW ports A and B as shown, and ends of the signal bridging conductors 36b, 36c are connected to the signal strip conductors 26 of the CPW ports A and B, as shown; and on the MMIC module 14 side of the assembly, ends of the ground plane bridging conductors 36a and 36d are connected to the ground plane conductor 37 (FIG. 4, 4B) on the bottom of the MMIC 16 through ground pads 40a, 40b serially connected capacitors 42a, 42b, and conducive vias 44a, 44b, respectively as shown, and ends of the signal bridging conductors 36b, 36c are connected to the signal strip conductors 33, 33 on the upper surface of the MMIC board 16, as shown more clearly in FIG. 4B. More particularly, as shown in FIG. 4B, as shown for an exemplary of the ground plane bridging conductors 36a, 36d, here conductor 36d, is connected to a ground pad 40b on the MMIC 14. Each one of the capacitors 42a, 42b has a pair of plates 52a, 52b as shown more clearly for an exemplary one thereof, here for an example one capacitor 42b in FIG. 4B. Thus, here one end of the bridging capacitor 42b is connected to plate 52a of the capacitor 42a; the second plate 45b of the capacitor 42a is connected to a top of a ground via 44a, which passes through the dielectric 35 of the MMIC 16 to the ground plane conductor 37 on the bottom of the MMIC 16. The two plates 52a, 52b of the capacitor are separated by a dielectric 53.

The ground plane bridging conductors 36a, 36d have inherent inductance L, as represented by the series inductor shown in FIG. 4C. The capacitors 42a, 42c have capacitance C, as represented in FIG. 4C. The value of the capacitance C is selected such that C=1/(2πf)²L, where f is the nominal operating frequency of the assembly 10; the frequency of the signal to be coupled between ports A, B and C, D respectively. Thus, bridging ground plane conductor and the capacitor form a series resonant circuit tuned to a frequency of RF energy passing through the ground bridging conductor to ground.

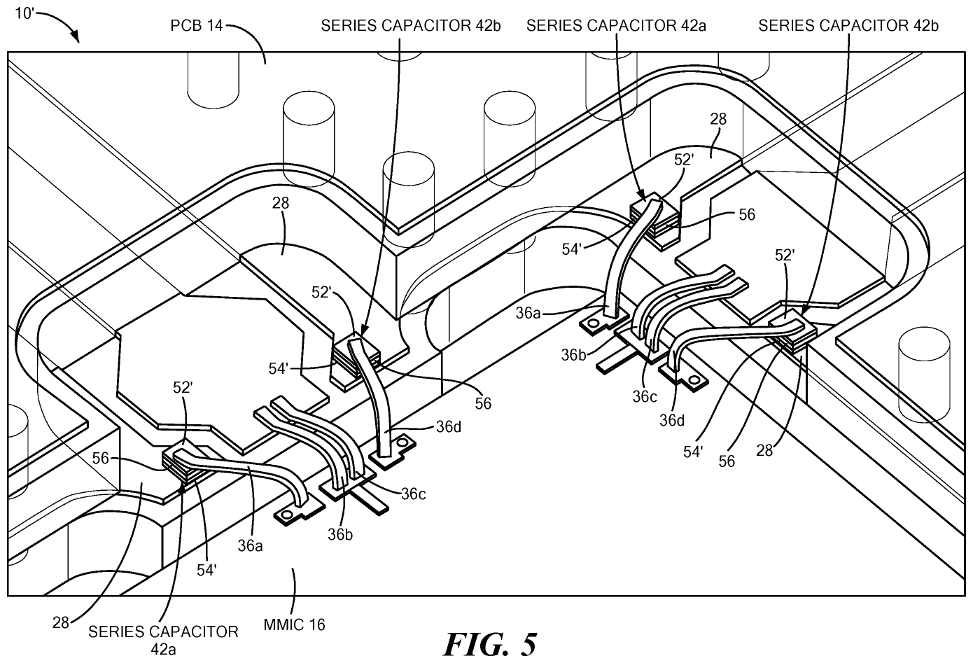

Referring now to FIG. 5, here the series capacitors 42′a, 42′b are disposed on the PCB side of an assembly 10′, as shown. More particularly, as shown in FIG. 5, the ground plane bridging conductors 36a, 36d, are connected to top plates 52′ of the capacitors 42′a, 42′b. The bottom plates 54′ of capacitors 42′a, 42′b are disposed on ground conductors 28 on the MMIC 16. The top plates 52′ and bottom plates 54; are separated by dielectric 56. Here again, the value of the capacitance C is selected such that C=1/(2πf)²L, where f is the nominal operating frequency of the assembly 10; the frequency of the signal to be coupled between ports A, B and C, D respectively.

A number of embodiments of the disclosure have been described. Nevertheless, it will be understood that various modifications may be made without departing from the spirit and scope of the disclosure. Accordingly, other embodiments are within the scope of the following claims.

What is claimed is:

1. An assembly having interconnected radio frequency (RF) modules, comprising:
a first RF module having a port, such port having a first signal conductor and a first ground plane conductor;
a second RF module having a port spaced from the port of the first RF module and having a second signal conductor and a second ground plane conductor;
a ground bridging conductor bridging the space between the ports of the first and second RF module and having a first end connected to the first ground plane conductor and a second end connected to the second ground plane conductor;
a signal bridging conductor bridging the space between ports of the first and second RF module and having a first end connected to the first signal conductor and second end connected to the second signal conductor; and
a capacitor connected between the ground plane bridging conductor and one of the first ground plane conductor and the second ground plane conductor.

2. An assembly, comprising:
a first RF module, comprising:
a first dielectric substrate;
a first signal strip conductor disposed on a surface of the first dielectric substrate; and,
a first ground plane conductor disposed on the surface of the first substrate and arranged to support RF energy between the first signal conductor and the first ground plane conductor;
a second RF module, comprising:
a second dielectric substrate;
a second signal strip conductor disposed on a surface of the second dielectric substrate;
a second ground plane conductor, disposed on a surface of the second substrate under the surface having thereon the second signal strip conductor, connected to the second ground plane conductor through the second dielectric substrate;
a ground bridging conductor having a first end connected to the first ground plane conductor and a second end connected to the second ground plane conductor;
a signal bridging conductor having a first end connected to the first signal conductor and second end connected to the second signal conductor;
a capacitor disposed connected between the ground plane bridging conductor and one of the first ground plane conductor and the second ground plane conductor.

3. The assembly recited in claim 2 wherein the capacitor is on disposed one of the first RF module and the second RF module.

4. The assembly recited in claim 2 wherein the bridging ground plane conductor and the capacitor form a series resonant circuit tuned to a frequency of RF energy passing through the ground bringing conductor.

5. The assembly recited in claim 3 wherein the bridging ground plane conductor and the capacitor form a series resonant circuit tuned to a frequency of RF energy passing through the ground bringing conductor.
